(19) United States
(12) Patent Application Publication
(10) Pub. No.: US 2023/0252872 A1
(43) Pub. Date: Aug. 10, 2023

(54) COMBINATION SMOKE AND AIR QUALITY DETECTION

(71) Applicant: Carrier Corporation, Palm Beach Gardens, FL (US)

(72) Inventors: Callum Bailey, Lakewood Ranch, FL (US); Vipul Patel, Sarasota, FL (US); Dennis Gadonniex, Bradenton, FL (US)

(21) Appl. No.: 18/165,542

(22) Filed: Feb. 7, 2023

Related U.S. Application Data
(60) Provisional application No. 63/307,837, filed on Feb. 8, 2022.

(51) Int. Cl. G08B 17/107; G01N 21/53

(52) U.S. Cl. CPC G08B 17/107; G01N 21/532; G01N 2021/4792

(57) ABSTRACT

A life safety detector comprising a housing defining a dark photo detection chamber for receiving ambient material, at least one light source configured to emit light into the detection chamber, at least one light sensing device operable to receive light reflected from the ambient materials in the detection chamber; and a processing device coupled to the at least one light sensing device. In a first mode of operation, the light received by the at least one light sensing device within the dark photo detection chamber is indicative of smoke, and in a second mode of operation, the light received by the at least one light sensing device within the dark photo detection chamber is indicative of an indoor air quality.

### CROSS-REFERENCE TO RELATED APPLICATIONS

This application claims the benefit of U.S. Provisional Patent Application Ser. No. 63/307,837, filed Feb. 8, 2022, the contents of which are incorporated by reference herein in their entirety.

### BACKGROUND

Exemplary embodiments of the present disclosure relate to a detection device, and more particularly, to a detection device operable as a smoke detector and an air quality detector.

Common photoelectric smoke detectors include a light source and a photoelectric receiver to detect whether or not smoke is present. When there is no smoke in the optic chamber, and the optic chamber is empty or mostly empty, the photoelectric receiver typically receives a small amount of light reflected from the chamber surfaces. On the other hand, when smoke is present in the optic chamber, the photoelectric receiver receives more light due to the light being reflected from the smoke particles. When an amount of light received by the receiver exceeds a certain threshold, an alarm is triggered.

It is becoming more and more desirable to monitor the indoor air quality of the same space being monitored by the smoke detectors. Indoor air quality may be monitored by detecting the presence of air pollutants, such as PM_{2.5} and PM₁₀, for example. Such monitoring is typically performed by separate indoor air quality sensors. Commercially available indoor air quality sensors typically use a laser and a fan to supply air to the interior of the sensor. Integration of such a sensor into an existing smoke detector is challenging because the laser consumes more power than is typically available within a smoke detector. In addition, inclusion of a fan poses a risk of blowing smoke away from the detector.

### BRIEF DESCRIPTION

According to an embodiment, a life safety detector comprising a housing defining a dark photo detection chamber for receiving ambient material, at least one light source configured to emit light into the detection chamber, at least one light sensing device operable to receive light reflected from the ambient materials in the detection chamber; and a processing device coupled to the at least one light sensing device. In a first mode of operation, the light received by the at least one light sensing device within the dark photo detection chamber is indicative of smoke, and in a second mode of operation, the light received by the at least one light sensing device within the dark photo detection chamber is indicative of an indoor air quality.

In addition to one or more of the features described herein, or as an alternative, in further embodiments the housing defining the detection chamber further comprises a base and an optical cover mounted to the base, the detection chamber being formed between the base and an interior surface of the optical cover.

In addition to one or more of the features described herein, or as an alternative, in further embodiments the optical cover has a wall, the wall being arranged at a non-perpendicular angle to the base.

In addition to one or more of the features described herein, or as an alternative, in further embodiments the wall is arranged between about 40° and about 75° relative to the base.

In addition to one or more of the features described herein, or as an alternative, in further embodiments the detection chamber further comprises a light trapping feature.

In addition to one or more of the features described herein, or as an alternative, in further embodiments the light trapping feature further comprises a tower extending from the base, the tower is positioned within the detection chamber to block light emitted from the at least one light source from being directly received by the at least one light sensing device.

In addition to one or more of the features described herein, or as an alternative, in further embodiments at least a portion of the tower further comprises a plurality of ridges.

In addition to one or more of the features described herein, or as an alternative, in further embodiments the optical cover has a wall and the light trapping feature further comprises a plurality of linear terraces formed at the interior surface of the wall.

In addition to one or more of the features described herein, or as an alternative, in further embodiments each of the plurality of linear terraces has a tooth, and adjacent teeth are arranged at a non-parallel angle relative to one another.

In addition to one or more of the features described herein, or as an alternative, in further embodiments the base further comprises at least one mounting portion having a channel for supporting one or more of the at least one light source and the at least one light sensing device, the light trapping feature further comprises a plurality of spiral ridges formed at the channel.

In addition to one or more of the features described herein, or as an alternative, in further embodiments at least one of the base and the optical cover includes carbon black.

In addition to one or more of the features described herein, or as an alternative, in further embodiments at least one of the base and the optical cover has a surface resistivity between about 10 ohm-cm and about 1000 ohm-cm.

In addition to one or more of the features described herein, or as an alternative, in further embodiments a surface of at least one of the base and the optical cover facing the detection chamber is roughened.

In addition to one or more of the features described herein, or as an alternative, in further embodiments at least one of the light sensing devices features an optical filter.

In addition to one or more of the features described herein, or as an alternative, in further embodiments the optical filter selectively removes light of specified wavelengths.

In addition to one or more of the features described herein, or as an alternative, in further embodiments the optical filter selectively removes light of specified polarizations.

According to an embodiment, a method of operating a life safety detector includes switching from a first mode for detecting smoke to a second mode for monitoring an indoor air quality, transmitting a light from at least one light source into a detection chamber positioned within an interior of a housing of the life safety detector, and receiving a scattered light within the detection chamber at a light sensing device. The scattered light is indicative of a presence of airborne particles having a diameter less than 2.5 micrometers and 10 micrometers.

In addition to one or more of the features described herein, or as an alternative, in further embodiments switching from the first mode for detecting smoke to the second mode for monitoring the indoor air quality further comprises at least one of increasing an intensity of the light transmitted from the at least one light source relative to the first mode and increasing a time that the at least one light source is energized relative to the first mode.

In addition to one or more of the features described herein, or as an alternative, in further embodiments a wavelength of the light transmitted from the at least one light source during the second mode is different than the wavelength of the light transmitted from the at least one light source during the first mode.

In addition to one or more of the features described herein, or as an alternative, in further embodiments the light transmitted from the at least one light source during the second mode is infrared.

### BRIEF DESCRIPTION OF THE DRAWINGS

The following descriptions should not be considered limiting in any way. With reference to the accompanying drawings, like elements are numbered alike:

FIG. 1 is a perspective view of an exemplary life safety detector according to an embodiment;

FIG. 1a is a partially exploded perspective view of the life safety detector of FIG. 1 according to an embodiment;

FIG. 2 is a plan view of a portion of a life safety detector according to an embodiment;

FIG. 3 is a perspective view of an exemplary optical chamber assembly of a life safety detector according to an embodiment;

FIG. 4 is a perspective view of a portion of the optical chamber assembly of FIG. 3 according to an embodiment;

FIG. 5 is a schematic diagram of an exemplary control system of a life safety detector according to an embodiment;

FIG. 6 is flow diagram illustrating an exemplary method of monitoring an indoor air quality using the optical chamber assembly according to an embodiment;

FIG. 7 is a perspective view of an exemplary optical chamber assembly including a light trapping feature according to an embodiment;

FIG. 8 is cross-sectional view of the optical cover of FIG. 7 according to an embodiment;

FIG. 9a is a perspective view of an interior surface of the optical cover of FIG. 7 according to an embodiment;

FIG. 9b is a detailed plan view of the linear terraces of the optical cover of FIG. 9a according to an embodiment; and

FIG. 10 is a plan view of a mounting portion of the optical chamber assembly according to an embodiment.

### DETAILED DESCRIPTION

A detailed description of one or more embodiments of the disclosed apparatus and method are presented herein by way of exemplification and not limitation with reference to the Figures.

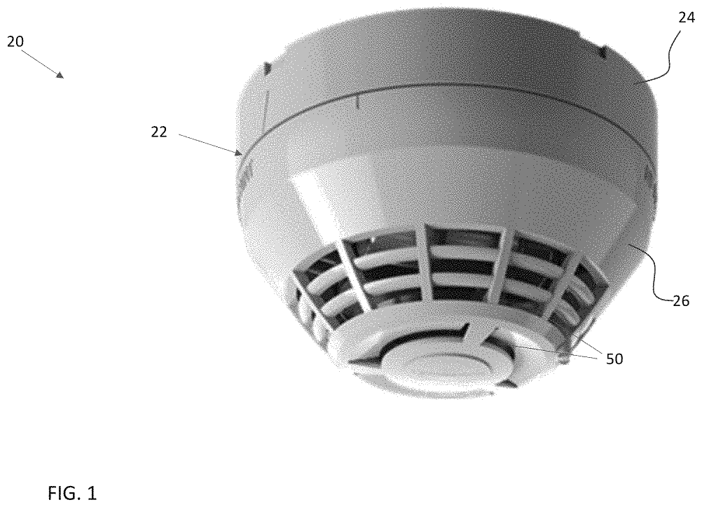

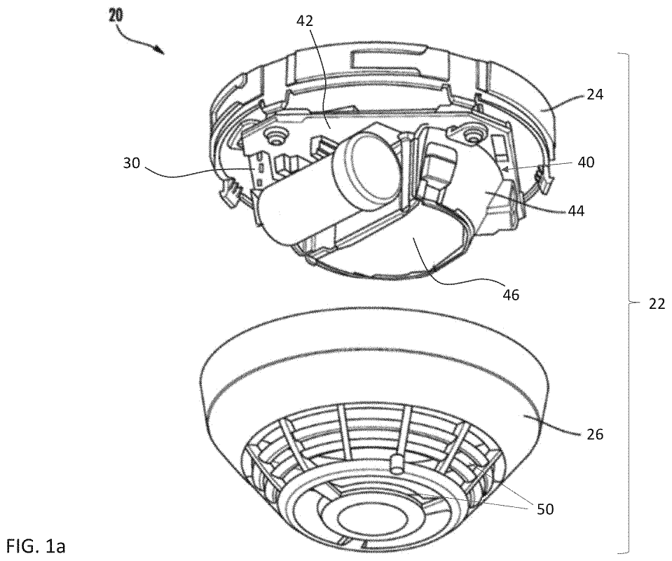

With reference now to FIGS. 1, 1a, and 2, an example of a life safety detector 20, such as a photoelectric smoke detector or alarm for example, is illustrated. As shown, the life safety detector 20 includes a housing 22 including a first upper housing portion 24 and a second, lower housing portion 26 that is permanently or removably connected to the first housing portion 24. When the first and second housing portions 24, 26 are connected, the first and second housing portions 24, 26 enclose the controls and other components necessary for operation of the device 20. As used herein, the terms “upper”, “lower”, and the like are in reference to the device 20 in use as it is mounted on a surface, such as a ceiling in a building for example. Therefore, the upper housing portion 24 is typically closer to the ceiling than the lower housing portion 26, and the lower housing portion 26 is typically the portion of the device 20 that will face downward toward the floor of the building. In some embodiments, device 20 may be mounted on a wall such that upper housing portion 24 is closer to the wall than the lower housing portion 26, and the lower housing portion 26 is typically the portion of the device 20 that will face outward toward the interior space of the room or space to be monitored.

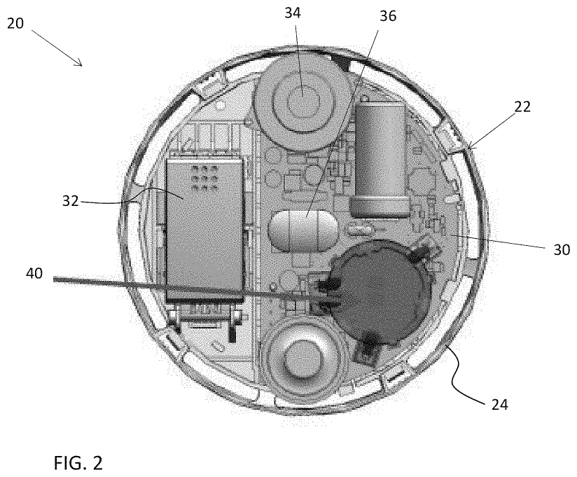

As shown in FIG. 3, the life safety detector 20 further includes controls including a printed circuit board 30 disposed within the upper housing portion. The printed circuit board 30 includes the circuitry and/or components associated with at least one detection circuit (not shown) and at least one alarm circuit (not shown). In some embodiments, the device 20 may be hardwired to a power source (not shown) located within the building or area where the device 20 is mounted, remote from the device 20. In such embodiments, the printed circuit board 30 may be directly or indirectly connected to the power source. In an embodiment, the device 20 may include a compartment 32 for receiving one or more batteries sufficient to provide the power necessary to operate the device 20 for an extended period of time. In an embodiment, the power provided by the batteries may be the sole source of power used to operate the device 20. However, in other embodiments, the battery power may be supplemental to the remote power source, for example in the event of a failure or loss of power at the power source.

A sound generation mechanism 34 may be connected to the printed circuit board 30 within the housing 22. The sound generation mechanism 34 may be operable to receive power from the printed circuit board 30 to generate a noise in response to detection of a condition. In addition, one or more actuatable mechanisms 36, such as a button for example, may be connected to the printed circuit board 30 and is received within an opening formed in the lower housing portion 26. The actuatable mechanism 36 may be configured to perform one or more functions of the life safety detector 20 when actuated. Examples of operations performed via the actuatable mechanism 36 include, but are not limited to, a press to test function, a smoke alarm “hush”, a low battery “hush”, and end of life “hush”, radio frequency enrollment of additional life safety detectors 20 such as in a detection system including a plurality of life safety detectors configured to communicate with one another wirelessly, and to reset the unit once removed from its packaging. Although the actuatable mechanism 36 is shown positioned at the center of the lower housing portion 26, embodiments where the actuatable mechanism 36 is located at another position are also within the scope of the disclosure.

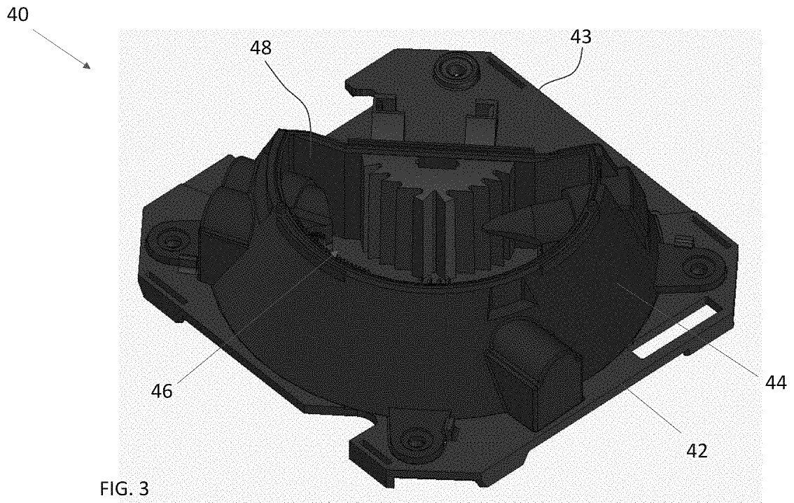

With continued reference to FIG. 2 and further reference to FIGS. 3 and 4, the life safety detector 20 additionally includes one or more components that define an optical chamber assembly 40 within the interior of the housing 22. The optical chamber assembly 40 is generally open to or in fluid communication with the area surrounding the life safety detector 20 and is thus receptive of ambient materials through a grating or another similar feature. The ambient materials may include air as well as smoke and non-smoke particles that are carried by the air.

The optical chamber assembly 40 includes a base 42. The circuit board 30 may be positioned between the base 42 and the upper housing portion 24 to mechanically support and electrically connect electronic components of the device 20. An optical cover 44 is removably or permanently attached to the base 42 adjacent a first surface 43 thereof. Accordingly, a detection chamber 46 is formed between the interior surface 48 of the optical cover 44 and the surface 43 of the base 42.

As shown in FIG. 1, the lower housing portion 26 includes at least one entry portion 50 through which air having particles entrained therein may enter into the life safety detector 20. The lower housing portion 26 may be connectable to the upper housing portion 24 in overlapping arrangement with the optical cover 40. As a result, the one or more entry portions 50 are arranged in fluid communication with and form part of a fluid flow path for delivering air and any particles entrained therein from the atmosphere surrounding the device 20 into the detection chamber 46.

As shown in FIG. 4, the optical chamber assembly 40 additionally includes at least one light source, such as a light emitting diode for example. In the illustrated, non-limiting embodiment, the at least one light source includes a first light source 52a, a second light source 52b, and a third light source 52c. However, it should be understood that embodiments having a single light source, two light sources, or more than three light sources, are within the scope of the disclosure. The base includes at least one mounting portion for supporting the at least one light source. As shown, the first light source 52a and the second light source 52b are arranged at a first mounting portion 54a relative to the base 42. Embodiments where the first light source 52a and the second light source 52b are mounted to distinct mounting portions at the same or different locations relative to the detection chamber 46 are contemplated herein.

The first light source 52a and the second light sources 52b may be selected to emit light having different wavelengths. For example, the first light source 52a may emit a first light having a first color and the second light source 52b may emit a second light having a second, distinct color. Alternatively, the first light source 52a may emit a first light within a visible spectrum and the second light source 52b may emit a second light outside of the visible spectrum, such as infrared light for example.

A second mounting portion 54b, located remotely from the first mounting portion 54a, may be configured to support the third light source 52c. Further, in an embodiment, the third light source 52c is arranged at an angle to the light emitted by the first and second light sources 52a, 52b and may emit light having the same wavelength and/or color or a different wavelength and/or color than the first and second light sources 52a, 52b. It should be understood that in an embodiment, a single light source, such as the first light source 52a for example, may be operable to emit light at two or more different wavelengths. Examples of such a light source includes, but is not limited to a bi-color LED. In such embodiments, the optical chamber assembly 40 may have only the single light source, or alternatively, may include multiple light sources, at least one of which is configured to emit light at a plurality of different wavelengths.

The optical chamber assembly 40 additionally includes at least one light sensing device or light receiver 56. Examples of a light sensing device or a light receiver 56 include, but are not limited to a photodiode, an Avalanche PhotoDiode (APDs), a Multi-Pixel Photon Counters (MPPCs), or another suitable photodetector. Although a single light receiver 56 is illustrated in the FIGS., it should be understood that in other embodiments, the optical chamber assembly 40 may include two or more light receivers. In an embodiment, a third mounting portion 54c, separate from the first and second mounting portions 54a, 54b, is operable to support the light receiver 56.

As shown in FIG. 4, the light receiver 56 is disposed to receive light that is emitted by one of the light sources 52a, 52b, 52c and that is then reflected by the ambient materials within the detection chamber 46 toward the light receiver 56. Although not shown in the FIGS., the light emitted from each of the light sources defines an emitter cone. Accordingly, in the illustrated, non-limiting embodiment, the light emitted from the first light source 52a defines a first emitter cone, the light emitted by the second light source 52b defines a second emitter cone, and the light emitted by the third light source 52c defines a third emitter cone. The at least one light receiver 56 similarly has a receiving cone associated therewith. The volume where each emitter cone overlaps with the receiving cone is defined as a sensing volume. Accordingly, in the illustrated, non-limiting embodiment, a first sensing volume is defined between the first emitter cone and the receiving cone, a second sensing volume is defined between the second emitter cone and the receiving cone and a third sensing volume is defined between eh third emitter cone and the receiving cone.

The light receiver 56 may be configured to generate an electric output signal in accordance with light being received. That is, for light that is emitted by the first light source 52a, reflected by the ambient materials in the detection chamber 46 and then received by the light receiver 56, the light receiver 56 generates a first output signal. Similarly, for light that is emitted by the second and third light sources 52b, 52c, reflected by the ambient materials in the detection chamber 46 and then received by the light receiver 56, the light receiver 56 generates a second and third output signal, respectively. It should be understood that in addition to each of the light sources 52a, 52b, 52c being arranged at an angle relative to the light receiver 56, each of the mounting portions 54a, 54b, 54c may be oriented such that the corresponding light source 52a, 52b, 52c or light receiver 56 located thereat is arranged at a desired angle relative to a horizontal plane.

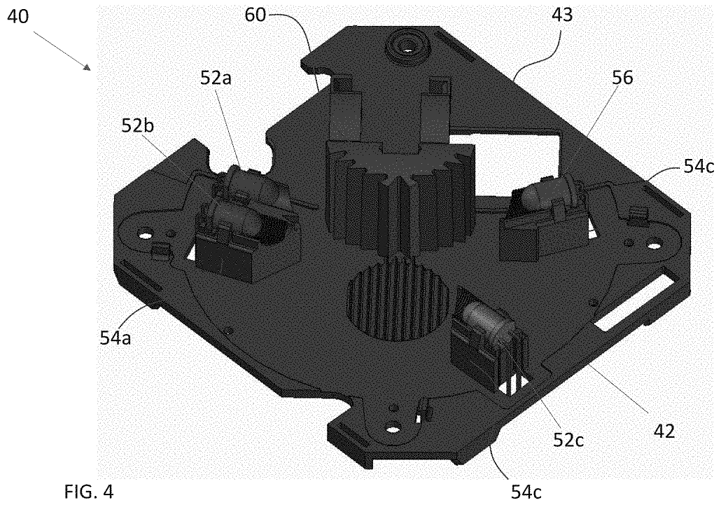

With reference now to FIG. 5, the life safety detector 20 further includes a processing device C in electrical communication with the plurality of light sources 52a, 52b, 52c, and the light receivers 56. The processing device C may be capable of accessing executable instructions, or may include a memory (not shown) capable of storing executable instructions. The executable instructions may be stored or organized in any manner and at any level of abstraction, such as in connection with one or more applications, processes or routines to analyze the signals detected by the one or more light receivers to make alarm decisions after preset threshold levels are reached according to the method described herein.

The life safety detector 20 may be operable in a plurality of modes. In an embodiment, the life safety detector 20 is configured to detect the presence of smoke within the ambient atmosphere surrounding the life safety detector 20 during operation in a first mode and is configured to monitor the indoor air quality of the ambient atmosphere surrounding the life safety detector 20 during operation in a second mode. Monitoring of indoor air quality as described herein relates to the detection of dust or other airborne particles referred to as PM_{2.5} particles (those particles having a diameter of 2.5 micrometers or less) and PM₁₀ particles (those particles having a diameter of 10 micrometers or less).

In an embodiment, the life safety detector includes additional components or electronics associated with operation in the second or “indoor air quality” mode. Such components may be used to improve the detection sensitivity of the life safety detector. In an embodiment, the additional components include an analog to digital converter and/or an optical filter. The optical filter may be configured to filter out undesired wavelengths, such as wavelengths outside of the wavelengths emitted by the light sources 52a, 52b, and 52c, or to preferentially detect with a specific polarization or scattered light from PM_{2.5} particles or smoke particles over light reflected from the side of the chamber.

One or more parameters associated with sampling of the atmosphere within the detection chamber 46 of the optical chamber assembly, may be the same, or alternatively, may vary based the mode of operation of the life safety detector. For example, the sensing volumes and/or wavelengths may be different for the smoke detection mode and indoor air quality mode. Alternatively, or in addition, operation in the indoor air quality mode may include amplification of the detection circuit at the processor C, such as by using additional bits on the analog to digital converter to increase the resolution of the signal. Further, the indoor air quality mode may have an increased time during which at least one light source 52a-52c is energized compared to operation in the first “smoke detection” mode, and/or increased intensity or brightness of light emitted by a light source 52a-52c (due to an increased power input) relative to operation in the “smoke detection” mode. In an embodiment, the reference voltage of the analog to digital converter varies between the smoke detection mode and the indoor air quality mode.

The life safety detector 20 may be configured to automatically transform between operation in the first smoke detection mode and operation in the second indoor air quality mode at predetermined intervals. In response to detection of an increased presence of smoke or particulate matter, such as a level that is not elevated enough to trigger an alarm, the timing of the intervals may be delayed or paused. Further, the intervals at which measurements are taken during operation in the smoke detection mode may be the same, or alternatively, may be different than the intervals at which measurements are taken during operation in the indoor air quality mode. Further, it should be understood that embodiments where operation in either mode includes continuous monitoring rather than sampling at intervals is also within the scope of the disclosure.

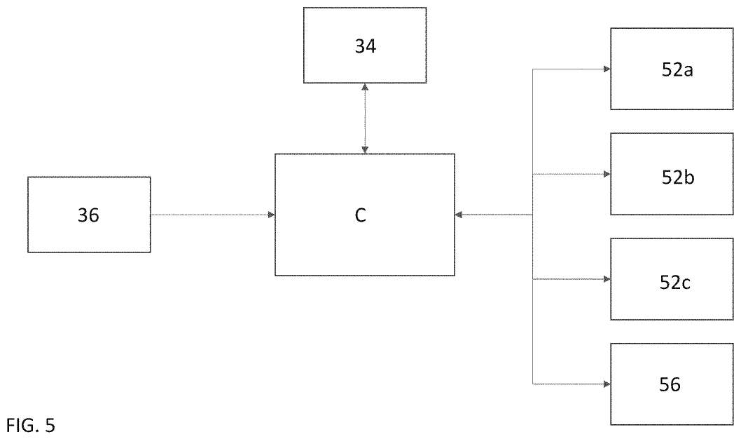

Referring now to FIG. 6, a flow chart of a method of operating the life safety detector 20 to monitor indoor air quality is illustrated. As shown at block 102, the life safety detector 20 is transitioned to operation in the indoor air quality mode used for airborne particle detection. At block 104, light is transmitted from the smoke detector, for example via the second light source 52b. At block 106, the transmitted light is scattered by any airborne particles in the path of the transmitted light within the detection chamber 46. At block 108, the scattered light is received at the light receiver 56 and at block 110 the processing device C is utilized to analyze the scattered light received at the light sensing devices 16, 18, 20 for the presence of the airborne particles, such as PM_{2.5} and PM₁₀ particles. In an embodiment, the steps shown in block 104-110 are repeated using another light source of the optical chamber assembly 40, such as the first light source 52a. The processing device C may further evaluate a ratio of the scattered light received at the light receiver 56 in response to operation of the second light source 52b with the scattered light received at the light receiver 56 in response to operation of the first light source to determine a particle size.

Existing indoor air quality sensors, which are high sensitivity sensors, typically have a highly absorbent chamber that allows for intense energy emission from a light source, such as a light emitting diode. This energy can be used to detect very low concentrations of particles using the principles of Mie light scattering. Existing chambered smoke detectors do not typically include a chamber that can absorb large amounts of excess light energy, and therefore that is suitable to perform indoor air quality monitoring. Accordingly, a configuration of the optical chamber assembly 40 of the life safety detector 20 may be optimized to create a detection chamber 46 having an energy absorbing effect. Such a highly absorbent chamber may also be referred to herein as a “dark photo detection chamber.”

A highly absorbent chamber may be quantified by a “clean air count” which remains low even with a very high light intensity because there no particles are present to scatter the light and limited light is reflected from the walls of the chamber. This is distinguishable from a reflective chamber, commonly used in photodetectors, which may cause a light sensing device to reach saturation due to LED brightness even with no particles present in the chamber.

To create a dark photo detection chamber 46, at least one of the base 42 and the optical cover 44 is composed of a substrate having a large concentration of carbon black filler. Examples of such a plastic substrate include polypropylene and nylon 6. Furthermore, the concentration of carbon black within the material is characterized by the surface resistivity of the material. In an embodiment, the substrate has a surface resistivity between about 10 ohm-cm and about 1000 ohm-cm. The surfaces of the base 42 and/or optical cover 44, such as facing the interior of the detection chamber 46 for example, may be smooth, or alternatively, may be roughened. A higher surface roughness will enhance the absorption of light.

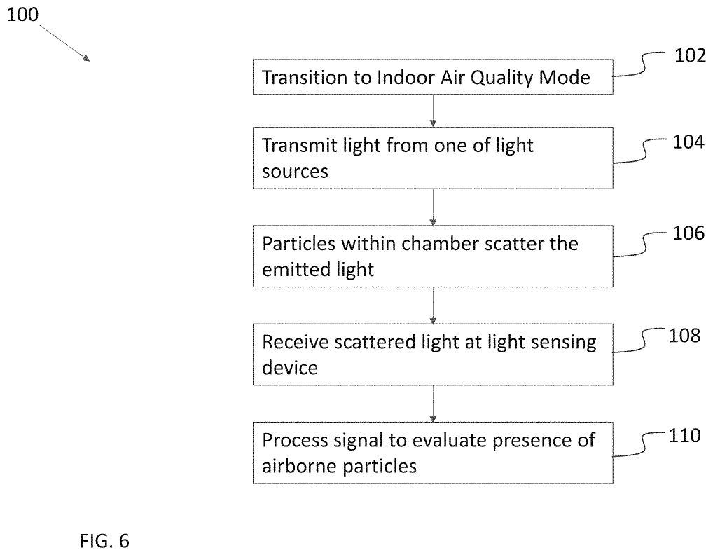

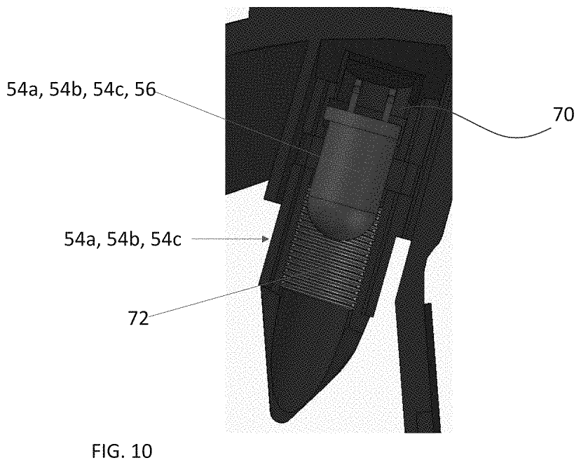

A geometry of the detection chamber 46 may be selected to enhance the light absorbing characteristics thereof. For example, light trapping features or geometries can be included to increase the number of reflections that occur before the excess light enters the light receiver. By increasing the number of reflections created, more light is absorbed by the target surface. With reference to FIGS. 7-10, several different light trapping features are illustrated. For example, a tower 60 may be coupled to and extend from the base 42. The tower 60 is located within the optical cover 44, such as at a side of the detection chamber 46. As shown, the tower 60 is positioned to shield or block the light receiver 56 from directly receiving light emitted from a light source, such as the first light source 52a for example.

In an embodiment, one or more sides of the tower 60 facing towards the interior of the detection chamber 46 and/or a light source 52a, 52b, 52c or light receiver 56, have a plurality of ridges 62 formed therein to increase the number of reflections and therefore the absorption within the detection chamber 46. Although the plurality of ridges 62 shown extend generally parallel to the longitudinal axis of the tower 60 (or perpendicular to the surface 43 of the base 42), embodiments where the ridges 62 have another configuration are within the scope of the disclosure.

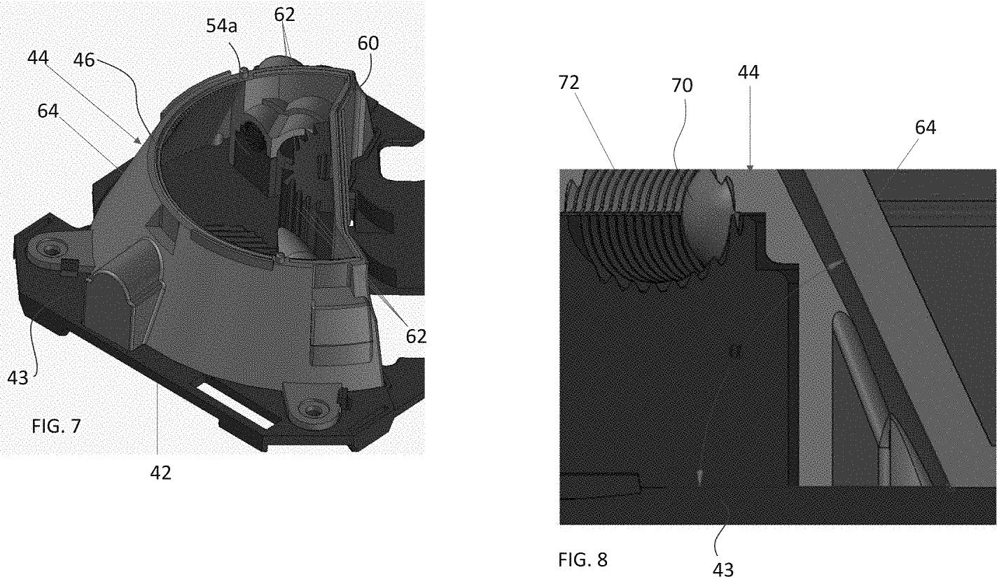

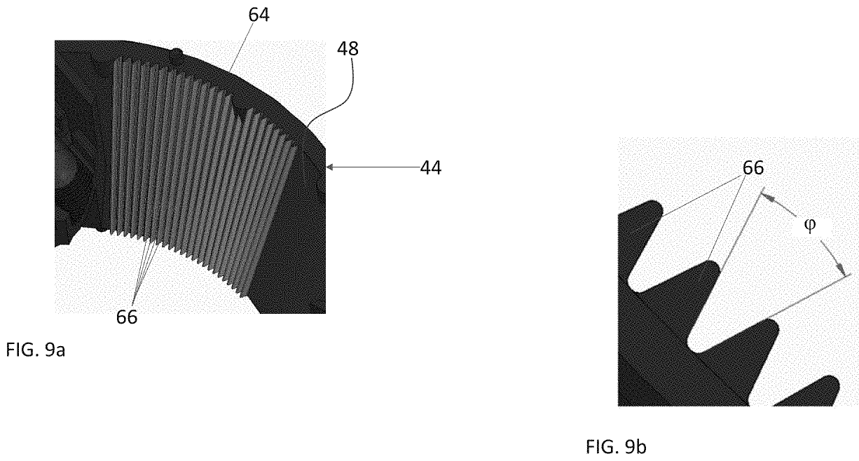

Alternatively or in addition, the optical cover 44 of the optical chamber assembly 40 includes one or more light trapping features. As shown, the optical cover 44 includes a curved or semi-circular portion. In the illustrated, non-limiting embodiment, the wall of the optical cover 44, such as the wall 64 of the curved portion thereof for example, is arranged at a non-perpendicular angle α to the base 42 (see FIG. 8). In an embodiment, the wall 64 is arranged at an angle between 40° and 75°, such as 65° for example. However, any angle less than 90° is contemplated herein. Further, as best shown in FIGS. 9a and 9b, one or more linear terraces 66 may be formed at an interior surface 48 of the optical cover 44, such as at the interior surface of the curved wall 64 for example, to increase the number of reflections and therefore the absorption within the detection chamber 46. The plurality of linear terraces 66 include a plurality of ridges or teeth extending over all or only a portion of the height of the wall 64 of the optical cover 44. In the illustrated, non-limiting embodiment, the surfaces of adjacent teeth are arranged at non-parallel angle, such as a 35° angle (φ), relative to one another (see FIG. 9b). However, embodiments where the teeth are arranged within another angle are also within the scope of the disclosure.

A mounting portion 54a, 54b, 54c configured to support a light source 52a, 52b, 52c and/or a light receiver 56 may be formed with a light trapping feature. Each of the light sources 52a, 52b, 52c and light receiver 56 is arranged within a channel 70 of a respective mounting portion 54a, 54b, 54c. In an embodiment, the optical cover may form a portion of the channel in combination with the mounting portion (see FIG. 8). In an embodiment, the channel 70 includes a plurality or circular or spiral ridges 72 formed therein which function as a light trapping feature. The plurality of spiral ridges 72 may be formed in only the part of the channel 70 defined by the mounting portion 54a, 54b, 54c, or alternatively, in both the mounting portion 54a, 54b, 54c and the optical cover 44 (see FIG. 8). It should be understood that the light trapping features illustrated and described herein are intended as an example only and that any suitable feature configured to increase light absorption within the detection chamber 46 is contemplated herein.

The embodiments disclosed herein allow for a single life safety detector 20 to detect and monitor other indoor air quality conditions, such as particulate contaminants, microbial contaminants or other conditions, in addition to smoke. This eliminates the need for additional, separately powered indoor air quality sensors to be utilized in the same space in which a smoke detector is placed, resulting in substantial consumer and business cost savings.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A life safety detector comprising:
a housing defining a dark photo detection chamber for receiving ambient materials;
at least one light source configured to emit light into the detection chamber;
at least one light sensing device configured to receive light reflected from the ambient materials in the detection chamber; and
a processing device coupled to the at least one light sensing device;
wherein in a first mode of operation of the life safety detector, the light received by the at least one light sensing device within the dark photo detection chamber is indicative of smoke, and in a second mode of operation of the life safety detector, the light received by the at least one light sensing device within the dark photo detection chamber is indicative of an indoor air quality.

2. The life safety detector of claim 1, wherein the housing defining the detection chamber further comprises:
a base; and
an optical cover mounted to the base, the detection chamber being formed between the base and an interior surface of the optical cover.

3. The life safety detector of claim 2, wherein the optical cover has a wall, the wall being arranged at a non-perpendicular angle to the base.

4. The life safety detector of claim 3, wherein the wall is arranged between about 40° and about 75° relative to the base.

5. The life safety detector of claim 2, wherein the detection chamber further comprises a light trapping feature.

6. The life safety detector of claim 5, wherein the light trapping feature further comprises a tower extending from the base, the tower is positioned within the detection chamber to block light emitted from the at least one light source from being directly received by the at least one light sensing device.

7. The life safety detector of claim 6, wherein at least a portion of the tower further comprises a plurality of ridges.

8. The life safety detector of claim 5, wherein the optical cover has a wall and the light trapping feature further comprises a plurality of linear terraces formed at the interior surface of the wall.

9. The life safety detector of claim 8, wherein each of the plurality of linear terraces has a tooth, and adjacent teeth are arranged at a non-parallel angle relative to one another.

10. The life safety detector of claim 5, wherein the base further comprises at least one mounting portion having a channel for supporting one or more of the at least one light source and the at least one light sensing device, the light trapping feature further comprises a plurality of spiral ridges formed at the channel.

11. The life safety detector of claim 2, wherein at least one of the base and the optical cover includes carbon black.

12. The life safety detector of claim 11, wherein at least one of the base and the optical cover has a surface resistivity between about 10 ohm-cm and about 1000 ohm-cm.

13. The life safety detector of claim 11, wherein a surface of at least one of the base and the optical cover facing the detection chamber is roughened.

14. The life safety detector of claim 2, wherein at least one of the light sensing devices features an optical filter.

15. The life safety detector of claim 14, wherein the optical filter selectively removes light of specified wavelengths.

16. The life safety detector of claim 14, wherein the optical filter selectively removes light of specified polarizations.

17. A method of operating a life safety detector comprising:
switching from a first mode for detecting smoke to a second mode for monitoring an indoor air quality;
transmitting a light from at least one light source into a detection chamber positioned within an interior of a housing of the life safety detector;
receiving a scattered light within the detection chamber at a light sensing device, wherein the scattered light is indicative of a presence of airborne particles having a diameter less than 2.5 micrometers and 10 micrometers.

18. The method of claim 17, wherein switching from the first mode for detecting smoke to the second mode for monitoring the indoor air quality further comprises at least one of increasing an intensity of the light transmitted from the at least one light source relative to the first mode and increasing a time that the at least one light source is energized relative to the first mode.

19. The method of claim 17, wherein a wavelength of the light transmitted from the at least one light source during the second mode is different than the wavelength of the light transmitted from the at least one light source during the first mode.

20. The method of claim 17, wherein the light transmitted from the at least one light source during the second mode is infrared.
